(19) United States
(12) Patent Application Publication
(10) Pub. No.: US 2014/0329091 A1
(43) Pub. Date: Nov. 6, 2014

(54) COMPOSITIONS AND METHODS FOR MAKING CROSS-LINKED POLYOLEFINS

(71) Applicant: Dow Global Technologies LLC, Midland, MI (US)

(72) Inventors: Jeffrey M. Cogen, Flemington, NJ (US); Thomas H. Peterson, Midland, MI (US); Kyoung M. Koh, Midland, MI (US); John J. Yang, Lake Jackson, TX (US); Dakai Ren, Midland, MI (US); Tanya Singh Rachford, Midland, MI (US); Yabin Sun, Shanghai (CN)

(73) Assignee: DOW GLOBAL TECHNOLOGIES LLC, Midland, MI (US)

(21) Appl. No.: 14/359,336

(22) PCT Filed: Dec. 21, 2012
(86) PCT No.: PCT/CN2012/087188

§ 371 Date: May 20, 2014

Related U.S. Application Data
(60) Provisional application No. 61/578,924, filed on Dec. 22, 2011.

(51) Int. Cl. H01B 3/44; B05D 1/26; H01B 3/42

(52) U.S. Cl. CPC H01B 3/447; H01B 3/421; B05D 1/265
USPC 428/394; 525/194; 427/120

(57) ABSTRACT

Interpolymer blends or terpolymers comprising ethylene monomer residues, residues of comonomers having carboxylic acid and/or carboxylic acid anhydride functionality, and residues of comonomers having epoxide functionality. Such interpolymer blends or terpolymers are cross-linkable materials suitable for use in cable polymeric coating applications and require little or no degassing after cross-linking.

### REFERENCE TO RELATED APPLICATIONS

The present application claims the benefit of U.S. Provisional Application No. 61/578,924, filed on Dec. 22, 2011.

### FIELD

Various embodiments of the present invention relate to cross-linkable polyolefins. Other aspects of the invention concern cross-linkable interpolymer blends suitable for use as insulation material for wire and cable applications.

### INTRODUCTION

Medium, high, and extra-high voltage (“MV,” “HV,” and “EHV”) cables typically contain a peroxide cross-linked polyethylene material as an insulation layer. Although cross-linking provides valuable improvement in thermomechanical properties of the material, the peroxide used for cross-linking creates byproducts that require removal from the material after it is formed into an insulation layer (e.g., by degassing) but before a jacketing layer is placed over the insulation layer. In the case of dicumyl peroxide, these byproducts include methane, acetophenone, alpha methylstyrene, and cumyl alcohol. Although work has been undertaken to discover an insulation material that does not require degassing, no viable solution has been identified. Accordingly, a need remains for a cross-linkable material suitable for use in wire and cable applications that requires little or no degassing after cross-linking.

### SUMMARY

One embodiment is a composition comprising: a first interpolymer comprising ethylene monomer residues and residues of a first comonomer having one or more functionalities selected from the group consisting of carboxylic acid and carboxylic acid anhydride; a second interpolymer comprising ethylene monomer residues and residues of a second comonomer having epoxide functionality; and a catalyst.

Another embodiment is an insulated cable composition comprising: a conductor; and an insulation material, wherein said insulation material comprises an at least partially cross-linked polymeric network comprising a first interpolymer and a second interpolymer, wherein said first interpolymer comprises ethylene monomer residues and residues of a first comonomer having one or more functionalities selected from the group consisting of carboxylic acid and carboxylic acid anhydride, wherein said second interpolymer comprises ethylene monomer residues and residues of a second comonomer having epoxide functionality.

Yet another embodiment is a process for preparing an insulated cable, said process comprising:
(a) providing a conductor and a cross-linkable material;
(b) at least partially surrounding said conductor with at least a portion of said cross-linkable material; and
(c) cross-linking at least a portion of said cross-linkable material in the substantial absence of both free-radical initiators and bis-azide cross-linkers to thereby provide an insulation material,
   wherein said cross-linkable material comprises a first interpolymer comprising ethylene monomer residues and residues of a first comonomer having at least one functionality selected from the group consisting of carboxylic acid and carboxylic acid anhydride, wherein said cross-linkable material comprises a second interpolymer comprising ethylene monomer residues and residues of a second comonomer having epoxide functionality.

### DETAILED DESCRIPTION

Various embodiments concern compositions comprising at least two types of interpolymers, each comprising ethylene monomer residues and respectively comprising first and second comonomer residues. Alternately, various aspects concern compositions comprising a terpolymer comprising ethylene monomer residues, residues of the first comonomer, and residues of the second comonomer. Such a combination of interpolymers or terpolymer can be employed in a variety of commercial applications, including, but not limited to, insulation and jacketing applications for wires and cables.

As just noted, the first and second interpolymers, as well as the terpolymers, described herein comprise ethylene monomer residues. In addition, the interpolymers and terpolymers can include one or more alpha-olefin comonomer residues. In various embodiments, the alpha-olefin comonomer can be any C₃-C₂₀ alpha-olefin monomer, C₃ to C₁₂ alpha-olefin monomer, or C₃ to C₅ alpha-olefin monomer. Specific examples of such alpha-olefin monomers include, but are not limited to, propylene, 1-butene, 1-pentene, 4-methyl-1-pentene, 1-hexene, 1-octene, 1-decene, 1-dodecene, 1-tetradecene, 1-hexadecene, and 1-octadecene. The alpha-olefins can also contain a cyclic structure such as cyclohexane or cyclopentane, resulting in an alpha-olefin such as 3-cyclohexyl-1-propene (allyl cyclohexane) and vinyl cyclohexane. In various embodiments, the alpha-olefin comonomer can be selected from the group consisting of propylene, 1-butene, and mixtures thereof.

In certain embodiments, ethylene monomer constitutes at least 50 weight percent (“wt %”) of the entire alpha-olefin content of the interpolymer. In one or more embodiments, ethylene can constitute at least 60 wt %, at least 70 wt %, at least 80 wt %, at least 90 wt %, at least 95 wt %, at least 99 wt %, substantially all, or all of the total alpha-olefin monomer content of the interpolymers or terpolymer.

As noted above, in addition to ethylene, the first interpolymer comprises residues of a first comonomer. The first comonomer has one or more functionalities selected from the group consisting of carboxylic acid and carboxylic acid anhydride. Additionally, the first comonomer can have at least one site of unsaturation to allow the first comonomer to polymerize. Illustrative examples of comonomers having carboxylic acid functionality include acrylic acid, methacrylic acid, maleic acid, and higher-order homologues thereof. An example of a comonomer having carboxylic anhydride functionality is maleic anhydride. In various embodiments, the first comonomer is selected from the group consisting of acrylic acid, maleic anhydride, and mixtures thereof. In certain embodiments, the first comonomer is acrylic acid. In some embodiments, the first comonomer is maleic anhydride.

The first interpolymer can comprise the first comonomer in an amount of at least 0.5 wt %, at least 1 wt %, or at least 2 wt % based on the total first interpolymer weight. Additionally, the first interpolymer can comprise the first comonomer in an amount ranging from 0.5 to 10 wt %, 1 to 5 wt %, or 2 to 4 wt %, which can be confirmed via analytical methods known in the art, such as one or more of Fourier transform infrared spectroscopy, nuclear magnetic resonance, and differential scanning calorimetry. In various embodiments, ethylene monomer residues constitute all or substantially all of the remainder of the first interpolymer. As used herein, the term “substantially all” excludes any non-specified component having a concentration greater than 10 parts per million by weight (“ppmw”).

The first interpolymer can have a melt index (“I₂”) in the range of from 1 to 50 dg/min., or in the range of from 3 to 7 dg/min., as determined according to ASTM D-1238 (190° C./2.16 kg). Furthermore, the first interpolymer can have a density in the range of from 0.85 to 0.97 g/cm³, or in the range of from 0.86 to 0.93 g/cm³, as determined according to ASTM D-792. Also, the first interpolymer can have a polydispersity index (i.e., weight average molecular weight/number average molecular weight; “Mw/Mn;” or molecular weight distribution (“MWD”)) in the range of from 1.5 to 20, or in the range of from 3 to 15, as determined by gel permeation chromatography.

An example of a commercially available interpolymer suitable for use as the first interpolymer is Lotader® 3210, available from Arkema, Inc.

As noted above, in addition to ethylene, the second interpolymer comprises residues of a second comonomer. The second comonomer has epoxide functionality. In various embodiments, the second comonomer comprises at least one epoxide functional group. Additionally, the second comonomer can have at least one site of unsaturation to allow the second comonomer to polymerize. Illustrative examples of comonomers having epoxide functionality include glycidyl esters of carboxylic acids, such as esters of those carboxylic acids noted above with respect to the first comonomer. Additionally, unsaturated glycidyl ethers may be employed as at least a portion of the second comonomer. Exemplary comonomers having epoxide functionality include glycidyl acrylate, glycidyl methacrylate, and allyl glycidyl ether. In certain embodiments, the second comonomer is glycidyl methacrylate.

The second interpolymer comprises the second comonomer in an amount of at least 0.5 wt %, at least 3 wt %, or at least 7 wt % based on the total second interpolymer weight. Additionally, the second interpolymer can comprise the second comonomer in an amount ranging from 0.5 to 20 wt %, 3 to 10 wt %, or 7 to 9 wt %. In various embodiments, ethylene monomer residues constitute all or substantially all of the remainder of the second interpolymer.

The second interpolymer can have a melt index (“I₂”) in the range of from 1 to 50 dg/min., or in the range of from 3 to 7 dg/min., as determined according to ASTM D-1238 (190° C./2.16 kg). Furthermore, the second interpolymer can have a density in the range of from 0.85 to 0.97 g/cm³, or in the range of from 0.86 to 0.93 g/cm³, as determined according to ASTM D-792. Also, the second interpolymer can have a polydispersity index in the range of from 1.5 to 20, or in the range of from 3 to 15, as determined by gel permeation chromatography.

An example of a commercially available interpolymer suitable for use as the second interpolymer is Lotader® AX 8840, available from Arkema, Inc.

Optionally, the first and/or second interpolymer can further comprise additional comonomer residues. Examples of such optional comonomers include olefins (as described above), dienes, vinyl silanes, unsaturated esters (e.g., ethyl acrylate), and acetates (e.g., vinyl acetate). Such optional monomer residues can be present in an amount ranging from 1 to 40 wt %, or from 5 to 20 wt %.

Any methods known or hereafter discovered for preparing an interpolymer can be employed to make the first and second interpolymers having the respective compositions described above. In various embodiments, the interpolymers can be prepared using processes known for making a high pressure low density polyethylene (“HP LDPE”). One conventional high pressure process is described in Introduction to Polymer Chemistry, Stille, Wiley and Sons, New York, 1962, pages 149 to 151. High pressure processes are typically free-radical initiated polymerizations conducted in a tubular reactor or a stirred autoclave. In such cases, the first and second comonomer residues are incorporated during polymerization of the first and second interpolymers, respectively. In alternative embodiments, the first and second comonomer residues can be incorporated by a grafting process. For example, an ethylene polymer, such as LDPE, can be melt mixed with one or more of the above-described first and/or second comonomers (e.g., maleic anhydride, acrylic acid, allyl glycidyl ether, or glycidyl methacrylate) in the presence of a peroxide or other free radical initiator to form the interpolymers comprising first and second comonomers.

Included in this disclosure is the non-limiting description of a free-radical initiated low density ethylene-based polymerization reaction. Besides feeding the reactor ethylene and, as described above, various comonomers, other components can be fed to the reactor to initiate and support the free-radical reaction as the interpolymer is formed, such as reaction initiators, catalysts, and chain transfer agents.

Various embodiments of the invention concern blends of the above-described first and second interpolymers. In such embodiments, the first and second interpolymers can be combined in any concentration ratio suited to achieve desired results. In certain embodiments, the first interpolymer can be present in the blend at a concentration of greater than 50 wt %, greater than 60 wt %, greater than 70 wt % or greater than 75 wt %, based on the combined first and second interpolymer weight. Additionally, the first interpolymer can be present in the blend in an amount ranging from 75 to 95 wt %, or 75 to 90 wt %, based on the combined first and second interpolymer weight.

Blends of the first and second interpolymers can be prepared by melt compounding the interpolymers at elevated temperature (i.e., greater than room temperature, but less than about 260° C.; e.g., 150° C.) employing conventional melt compounding techniques and equipment. Thereafter, the blended interpolymers can be extruded with melt filtration through a fine screen (e.g., 500 mesh) and optionally pelletized.

In various embodiments, at least 50 volume percent (“vol %”) of the resulting interpolymer blend can be a homogeneous blend. As used herein, the term “homogenous blend” denotes a composition having no distinct interpolymer domains having an average diameter larger than 3 micrometers (“μm”). In various embodiments, a homogenous blend of the above-described first and second interpolymers can have no distinct domains of either interpolymer larger than 2 μm, or larger than 1 μm, which can be assessed by microscopy techniques, such as FTIR microscopy, atomic force microscopy, scanning electron microscopy, transmission electron microscopy, and other methods known to those skilled in the art. Additionally, in various embodiments, at least 60 vol %, at least 70 vol %, at least 80 vol %, at least 90 vol %, substantially all or all of the interpolymer blend is a homogeneous blend.

In various embodiments, when the first and second interpolymers are incorporated into a blend in the absence of a cross-linking catalyst (such as described below) and stored at room temperature (e.g., 22 degrees Celsius (“° C.”)), the blend can exhibit little if any initial cross-linking. In various embodiments, from the time the above-described homogenous blend is achieved (designated “T_{b}”), the blend can exhibit a gel content of less than 50%, 30%, or 10% for up to sixty minutes past T_{b} (designated “T_{b+60}”) at a temperature less than or equal to the blending temperature described below. Gel content is determined according to ASTM D2765.

In alternate embodiments, a terpolymer is provided that comprises ethylene monomer residues, residues of the above-described first comonomer, and residues of the above-described second comonomer. The above-described monomer concentrations for ethylene, the first comonomer, and the second comonomer can also be employed in preparing such a terpolymer. Additionally, the terpolymer can be prepared employing the same polymerization techniques provided above. The terpolymer may optionally comprise other monomer units in addition to ethylene and the above-described first and second comonomers.

In an embodiment, the terpolymer comprises 0.5 to 8 wt % of the above described first and second comonomers.

The terpolymer can have a melt index (“I₂”) in the range of from 0.5 to 100 dg/min., or in the range of from 1 to 20 dg/min., as determined according to ASTM D-1238 (190° C./2.16 kg). Furthermore, the terpolymer can have a density in the range of from 0.85 to 0.97 g/cm³, or in the range of from about 0.86 to about 0.93 g/cm³, as determined according to ASTM D-792. Also, the terpolymer can have a polydispersity index in the range of from 1.5 to 20, or in the range of from 3 to 15, as determined by gel permeation chromatography.

In an embodiment, the first and second interpolymers are present in amounts ranging from 5 to 95 wt %, based on the combination of first and second interpolymers.

Without being bound by theory, having the functionality of the first and second comonomers incorporated into interpolymers has advantages in terms of low volatiles after crosslinking (even if reaction is not 100% complete) and compatibility during and after compounding.

In various embodiments, the above-described interpolymer blend or terpolymer can undergo cross-linking to form an at least partially cross-linked polymeric network. In such embodiments, the above-mentioned blend of the first and second interpolymers can be combined with a cross-linking catalyst to aid in cross-linking. In alternate embodiments, the terpolymer can be combined with a cross-linking catalyst to aid in cross-linking. The cross-linking catalyst useful in the present invention may include, for example, nucleophilic catalysts, tertiary amines, amine complexes, urea derivatives, imidazoles, substituted imidazoles, and Lewis bases having the ability to catalyze curing, and mixtures thereof. Depending on the catalyst and reaction conditions, the catalyst can optionally co-react into the formulation. The cross-linking catalyst useful in the present invention may include catalysts well known in the art for curing epoxy resins, such as catalyst compounds containing amine, phosphine, heterocyclic nitrogen, ammonium, phosphonium, arsonium, sulfonium moieties, and any combination thereof. Some non-limiting examples of cross-linking catalysts may include, for example, ethyltriphenylphosphonium; benzyltrimethylammonium chloride; heterocyclic nitrogen-containing catalysts described in U.S. Pat. No. 4,925,901; imidazoles; triethylamine; and any combination thereof. The selection of the cross-linking catalyst includes those that are commonly used for epoxy systems. Specific examples of cross-linking catalysts useful in the present invention include tertiary amines, 1-substituted imidazoles, organo-phosphines, and acid salts. Preferred cross-linking catalysts include tertiary amines such as, for example, triethylamine, tripropylamine, tributylamine, 1-methylimidazole, benzyldimethylamine, and mixtures thereof. In a preferred embodiment, the catalyst is 1-methylimidazole. An example of a commercially available cross-linking catalyst is Tinuvin® 765, available from BASF, which is a mixture of bis(1,2,2,6,6-pentamethyl-4-piperidyl) sebacate (70-90 wt %) and methyl 1,2,2,6,6-pentamethyl-4-piperidyl sebecate (15-30 wt %) (CAS Numbers: 41556-26-7; 8291-37-7).

In another embodiment, the catalyst is 2-methylimidazole.

The concentration of the cross-linking catalyst can range from 0.005 to 2 wt %, 0.01 to 1.5 wt %, or 0.1 wt % to 1 wt %, based on the combined cross-linking catalyst and polymer weights.

In one embodiment, cross-linking of the first and second interpolymers as well as the terpolymer can be performed in a curing zone having a temperature of at least 175° C. up to a maximum of about 260° C. Additionally, the interpolymers as well as the terpolymer can be cured for a time ranging from 2 minutes to about 30 minutes. In various embodiments, the curing zone can be a hot nitrogen tube.

In an alternate embodiment, cross-linking can take place at between room temperature and about 60° C. over a time period of 2 hours to 1 week.

In various embodiments, cross-linking of the first and second interpolymers or the terpolymer can be performed in the absence or the substantial absence of both free-radical initiators (e.g., peroxide initiators) and bis-azide cross-linkers. As used herein, the term “substantial absence” denotes a concentration of less than 10 ppmw.

The extent of cross-linking in the above-described materials can be determined via analysis on a moving die rheometer at 200° C. for 5 hours. Cross-linking extent is determined by the method described in ISO 6502. Upon analysis, an increase in torque, as indicated by the difference between the maximum torque (“MH”) and the minimum torque (“ML”) (“MH−ML”), indicates greater degree of cross-linking. In various embodiments, the cross-linked interpolymers or terpolymer can have an MH−ML of at least 0.4 inch-pounds (0.045 Newton meter (“N·m”)), at least 0.6 inch-pounds (0.068 N·m), at least 0.8 inch-pounds (0.090 N·m), at least 1 inch-pounds (0.113 N·m), at least 1.2 inch-pounds (0.136 N·m), at least 2 inch-pounds (0.226 N·m), at least 3, inch-pounds (0.339 N·m) or at least 4 inch-pounds (0.452 N·m). Additionally, the cross-linked interpolymers or terpolymer can have a maximum MH−ML of 15 inch-pounds. Additionally, the cross-linked interpolymers or terpolymer can have a gel content of at least 30%, or at least 50%, at least 70%, or at least 90% as determined using the ASTM D2765 method.

In various embodiments, the at least partially cross-linked interpolymer blend or terpolymer can have a volatiles content of less than 1.5, less than 1.0, less than 0.5, less than 0.1, or less than 0.01 wt %. The method used to assess volatiles content is to measure weight loss on a cross-linked sample via thermogravimetric analysis (“TGA”) in a nitrogen atmosphere. The change in sample mass is followed upon heating from 30° C. to 175° C. at a 50° C. per minute heating rate, then holding at 175° C. for 30 minutes. The amount of weight loss indicates the volatiles content. Illustrative examples of volatiles include water, methane, acetophenone, cumyl alcohol, and alpha-methylstyrene. In various embodiments, the at least partially cross-linked interpolymer blend or terpolymer has a combined concentration of water, methane, acetophenone, cumyl alcohol, and alpha-methylstyrene of less than 1.5, less than 1.0, less than 0.5, less than 0.1, or less than 0.01 wt %. Such volatiles concentrations are achieved without degassing the at least partially cross-linked interpolymer blend or terpolymer.

In various embodiments, the interpolymer blend or the terpolymer can be employed in preparing polymer coatings (e.g., insulation and/or jackets) for wires and/or cables. When employed in such articles of manufacture, the interpolymer blend or terpolymer may contain other additives including, but not limited to, processing aids, fillers, coupling agents, ultraviolet absorbers or stabilizers, antistatic agents, nucleating agents, slip agents, plasticizers, lubricants, viscosity control agents, tackifiers, anti-blocking agents, surfactants, extender oils, acid scavengers, flame retardants, and metal deactivators. Additives, other than fillers, are typically used in amounts ranging from 0.01 or less to 10 or more wt % based on total composition weight. Fillers are generally added in larger amounts although the amount can range from as low as 0.01 or less to 65 or more wt % based on the weight of the composition. Illustrative examples of fillers include clays, precipitated silica and silicates, fumed silica, calcium carbonate, ground minerals, aluminum trihydroxide, magnesium hydroxide, and carbon blacks with typical arithmetic mean particle sizes larger than 15 nanometers.

Additionally, an antioxidant can be employed with the polymeric coating material. Exemplary antioxidants include hindered phenols (e.g., tetrakis [methylene (3,5-di-t-butyl-4-hydroxyhydrocinnamate)]methane); phosphites and phosphonites (e.g., tris(2,4-di-t-butylphenyl)phosphate); thio compounds (e.g., dilaurylthiodipropionate); various siloxanes; and various amines (e.g., polymerized 2,2,4-trimethyl-1,2-dihydroquinoline). Antioxidants can be used in amounts of 0.1 to 5 wt % based on the total composition weight of the polymeric coating material. In the formation of wire and cable compositions, antioxidants are typically added to the system before processing (i.e., prior to extrusion and cross-linking) of the finished article.

Compounding of a cable polymeric coating material, such as insulation, can be effected by standard equipment known to those skilled in the art. Examples of compounding equipment are internal batch mixers, such as a Banbury™ or Bolling™ internal mixer. Alternatively, continuous single, or twin screw, mixers can be used, such as a Farrel™ continuous mixer, a Werner and Pfleiderer™ twin screw mixer, or a Buss™ kneading continuous extruder.

In various embodiments, a cable comprising a conductor and an insulation layer can be prepared employing the above-described interpolymer blend or terpolymer. A cable containing an insulation layer comprising the interpolymer blend or terpolymer can be prepared with various types of extruders (e.g., single or twin screw types). A description of a conventional extruder can be found in U.S. Pat. No. 4,857,600. An example of co-extrusion and an extruder therefore can be found in U.S. Pat. No. 5,575,965.

Following extrusion, the extruded intermediate cable can pass into a heated cure zone downstream of the extrusion die to aid in cross-linking the interpolymer blend or terpolymer in the presence of the above-described cross-linking catalyst. The heated cure zone can be maintained at a temperature in the range of 175 to 260° C. The heated zone can be heated by pressurized steam or inductively heated by pressurized nitrogen gas.

Following extrusion and cross-linking, the cable can be jacketed employing known cable manufacturing processes. In various embodiments, the cable does not undergo any degassing processes prior to such jacketing. Alternately, the jacket can be extruded along with the conductor and insulation material simultaneously, which heretofore was not possible with cross-linkable insulation due to degassing requirements for the insulation material.

Alternating current cables prepared according to the present disclosure can be low voltage, medium voltage, high voltage, or extra-high voltage cables. Further, direct current cables prepared according to the present disclosure include high or extra-high voltage cables.

### DEFINITIONS

As used herein, the term “and/or,” when used in a list of two or more items, means that any one of the listed items can be employed by itself or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

“Wire” means a single strand of conductive metal, e.g., copper or aluminum, or a single strand of optical fiber.

“Cable” and “power cable,” mean at least one wire or optical fiber within at least one polymeric coating material, e.g., an insulation covering or a protective outer jacket. Typically, a cable is two or more wires or optical fibers bound together, typically in a common insulation covering and/or protective jacket. The individual wires or fibers inside the polymeric coating material may be bare, covered or insulated. Combination cables may contain both electrical wires and optical fibers. The cable can be designed for low, medium, and/or high voltage applications. Typical cable designs are illustrated in U.S. Pat. Nos. 5,246,783, 6,496,629 and 6,714,707.

A “conductor” denotes one or more wire(s) or fiber(s) for conducting heat, light, and/or electricity. The conductor may be a single-wire/fiber or a multi-wire/fiber and may be in strand form or in tubular form. Non-limiting examples of suitable conductors include metals such as silver, gold, copper, carbon, and aluminum. The conductor may also be optical fiber made from either glass or plastic.

“Polymer” means a macromolecular compound prepared by reacting (i.e., polymerizing) monomers of the same or different type. “Polymer” includes homopolymers and interpolymers.

“Interpolymer” means a polymer prepared by the polymerization of at least two different monomers. This generic term includes copolymers, usually employed to refer to polymers prepared from two different monomers, and polymers prepared from more than two different monomers, e.g., terpolymers (at least three different monomers) and tetrapolymers (at least four different monomers). Interpolymers also include polymers prepared by grafting an unsaturated comonomer to a polymer. For example, an ethylene polymer, such as LDPE, can be melt mixed with and unsaturated comonomer, such as maleic anhydride, acrylic acid, allyl glycidyl ether, or glycidyl methacrylate in the presence of a peroxide or other free radical initiator to form interpolymers.

“Residue,” when referring to a monomer, means that portion of a monomer molecule which resides in a polymer molecule as a result of being polymerized with or grafted to another monomer or comonomer molecule to make the polymer molecule.

### Test Methods

### Density

Density is determined according to ASTM D 1928. Samples are pressed at 374° F. (190° C.) and 30,000 psi for three minutes, and then at 70° F. (21° C.) and 30,000 psi for one minute. Density measurements are made within one hour of sample pressing, using ASTM D792, Method B.

### Melt Index

Melt index, or I₂, is measured in accordance by ASTM D 1238, Condition 190° C./2.16 kg, and is reported in grams eluted per 10 minutes. The 110 is measured in accordance with ASTM D 1238, Condition 190° C./10 kg, and is reported in grams eluted per 10 minutes.

### Molecular Weight Distribution

The gel permeation chromatography (“GPC”) system consists of a Polymer Char GPC-IR High Temperature Chromatograph, equipped with an IR4 infra-red detector from Polymer ChAR (Valencia, Spain). Data collection and processing is performed using Polymer Char software. The system is also equipped with an on-line solvent degassing device.

Suitable high temperature GPC columns can be used, such as four 30 cm long Shodex HT803 13 micron columns, or four 30 cm Polymer Labs columns of 13-micron mixed-pore-size packing (Olexis LS, Polymer Labs). Here, the Olexis LS columns were used. The sample carousel compartment is operated at 140° C., and the column compartment is operated at 150° C. The samples are prepared at a concentration of 0.1 grams of polymer in 50 milliliters of solvent. The chromatographic solvent and the sample preparation solvent is 1,2,4-trichlorobenzene (“TCB”) containing 200 ppm of 2,6-di-tert-butyl-4-methylphenol (“BHT”). The solvent is sparged with nitrogen. The polymer samples are stirred at 160° C. for four hours. The injection volume is 200 microliters. The flow rate through the GPC is set at 1 mL/minute.

The GPC column set is calibrated by running 21 narrow molecular weight distribution polystyrene standards. The molecular weight (“MW”) of the standards ranges from 580 g/mol to 8,400,000 g/mol, and the standards are contained in 6 “cocktail” mixtures. Each standard mixture has at least a decade of separation between individual molecular weights. The standard mixtures are purchased from Polymer Laboratories. The polystyrene standards are prepared at 0.025 g in 50 mL of solvent for molecular weights equal to, or greater than, 1,000,000 g/mol, and at 0.05 g in 50 mL of solvent for molecular weights less than 1,000,000 g/mol. The polystyrene standards are dissolved at 80° C., with agitation, for 30 minutes. The narrow standards mixtures are run first, and in order of decreasing highest molecular weight component to minimize degradation. The polystyrene standard peak molecular weights are converted to polyethylene molecular weight using Equation (1) (as described in Williams and Ward, J. Polym. Sci., Polym. Letters, 6, 621 (1968)):

Mpolyethylene=A×(Mpolystyrene)^{B} (Eq. 1)

where M is the molecular weight of polyethylene or polystyrene (as marked), and B is equal to 1.0. It is known to those of ordinary skill in the art that A may be in a range of about 0.38 to about 0.44, and is determined at the time of calibration using a broad polyethylene standard, as discussed below. Use of this polyethylene calibration method to obtain molecular weight values, such as the molecular weight distribution (MWD or Mw/Mn), and related statistics, is defined here as the modified method of Williams and Ward. The number average molecular weight, the weight average molecular weight, and the z-average molecular weight are calculated from the following equations.

$$\begin{matrix}\begin{matrix}{Mw}_{CC} = {\sum }_{i}^{ } ( \frac{{C}_{i}}{{\sum }_{i}^{ } {C}_{i}} ) {M}_{i} \\ = {\sum }_{i}^{ } {w}_{i} {M}_{cc , i}\end{matrix} & ( Eq . 2 ) \\ {M}_{n , cc} = \sum {w}_{i} / \sum ( {w}_{i} / {M}_{cc , i} ) & ( Eq . 3 ) \\ {M}_{z , cc} = \sum ( {w}_{i} {M}_{cc , i}^{2} ) / \sum ( {w}_{i} {M}_{cc , i} ) & ( Eq . 4 )\end{matrix}$$

### EXAMPLES

### Test and Sample Preparation Procedures

### C.E. 2, C.E. 3, I.E. 1, I.E. 2, I.E. 3

Charge 50 g of the below-indicated formulations to a Brabender mixer outfitted with cam-type mixing blades that is pre-heated to 120° C. Mix the compositions for 5 minutes at 30 rotations per minute (“rpm”) mixing speed, then remove from the mixer. Evaluate a portion of the composition on a moving die rheometer (“MDR”) operating at 100 cycles per minute, and at an arc of 0.5 degrees, using a temperature of 200° C. for 5 hours. General information about test methods using MDR is available in ISO 6502. An increase in torque, as indicated by the maximum torque (“MH”) minus minimum torque (“ML”), is indicative of the degree of cross-linking, with a greater increase indicating more cross-linking.

### I.E. 7

A Haake mixer with 50 g capacity, operating at 30 rpm with roller rotor mixing blades is utilized under an argon atmosphere. PE1 is heated at 180° C. for 10 minutes to convert any hydrolyzed anhydride back to the anhydride form. It is then cooled to 135° C. and 2-methylimidazole is added, then the Haake is further cooled to 110° C. and PE2 is added followed by six minutes additional mixing time. The resulting compound is cured by compression molding at 200° C. for various times, then analyzed on a TA Instruments (New Castle, Del.) Q800 dynamic mechanical analyzer (DMA) to measure the storage modulus from −80 to 200° C. (frequency=1 Hz; heating rate=3° C./min). The storage modulus at the rubbery plateau (˜120-200° C.) is related to degree of crosslinking.

### Materials

PE1 is Lotader® 3210 obtained from Arkema, Inc. It is a random terpolymer of ethylene, butyl acrylate, and maleic anhydride, polymerized by high-pressure autoclave process. Melt index (190° C./2.16 kg) is 5 g/10 min. Butyl acrylate content is 6 wt %. Maleic anhydride content is 3.1 wt %. Weight percents are based on the total weight of the terpolymer.

PE2 is Lotader® AX 8840 obtained from Arkema, Inc. It is a random copolymer of ethylene and glycidyl methacrylate polymerized by high-pressure autoclave process. Melt index (190° C./2.16 kg) is 5 g/10 min. Glycidyl methacrylate content is 8 wt %. Weight percents are based on the total weight of the copolymer.

HALS1 is a tertiary amine-containing hindered amine light stabilizer obtained from BASF under the name Tinuvin® 765, and is a mixture of bis(1,2,2,6,6-pentamethyl-4-piperidyl)sebacate (70-90 wt %) and methyl 1,2,2,6,6-pentamethyl-4-piperidyl sebecate (15-30 wt %) (CAS Numbers: 41556-26-7; 8291-37-7). It is included in the inventive compositions as a cross-linking catalyst.

2-Methylimidazole, catalyst (CAS#693-98-1) was purchased from Aldrich.

PE3 is a low density polyethylene homopolymer produced in a high-pressure tubular process and contains 0.5 wt % antioxidants and about 2 wt % of dicumyl peroxide and has a melt index (190° C./2.16 kg) of about 2.3 g/10 min. Weight percents are based on the total weight of the polymer.

### Comparative Example 1

### Polyethylene Cross-Linked with Free-Radical Initiator

Evaluate PE3 in the MDR, giving a MH−ML of 2.52 inch-pounds (0.285 N·m). Though this material demonstrates a high level of cross-linking, the resulting cross-linked composition contains approximately 2 wt % of volatile peroxide byproducts after cross-linking.

### Comparative Example 2

### PE1 with HALS1 Cross-Linking Catalyst

Compound PE1 with 1 wt % of HALS1. Evaluate in the MDR. The MH−ML on the MDR for this composition is 0.01 inch-pounds (0.00113 N·m), indicating negligible amount of cross-linking.

### Comparative Example 3

### PE2 with HALS1 Cross-Linking Catalyst

Compound PE2 with 1 wt % of HALS1. Evaluate in the MDR. The MH−ML on the MDR for this composition is 0.02 inch-pounds (0.00226 N·m), indicating negligible amount of cross-linking.

### Comparative Example 4

### 50:50 PE1:PE2 without Catalyst

Prepare a 1:1 dry blend of PE1 and PE2 by first grinding separate samples of PE1 and PE2 and then physically mixing the resulting powders. Evaluate in the MDR. The MH−ML on the MDR for this composition is 0.02 inch-pounds (0.00226 N·m), indicating negligible amount of cross-linking occurs when a mixture of PE1 and PE2 is heated in the absence of HALS1.

### Example 1

### ˜25:75 PE1:PE2 with HALS1 Catalyst

Prepare a composition containing 24.5 wt % PE1, 74.5 wt % PE2, and 1.0 wt % of HALS1. Evaluate in the MDR. The MH−ML on the MDR for this composition is 0.46 inch-pounds (0.0520 N·m), indicating a significant amount of cross-linking. In contrast to Comparative Example 1, this composition does not contain significant amount of volatile byproducts after cross-linking.

### Example 2

### ˜50:50 PE1:PE2 with HALS1 Catalyst

Prepare a composition containing 49.5 wt % PE1, 49.5 wt % PE2, and 1.0 wt % of HALS1. The MH−ML on the MDR for this composition is 1.06 inch-pounds (0.120 N·m), indicating a significant amount of cross-linking. In contrast to Comparative Example 1, this composition does not contain significant amount of volatile byproducts after cross-linking.

### Example 3

### ˜75:25 PE1:PE2 with HALS1 Catalyst

Prepare a composition containing 74.5 wt % PE1, 24.5 wt % PE2, and 1.0 wt % of HALS1. The MH−ML on the MDR for this composition is 1.34 inch-pounds (0.151 N·m), indicating a significant amount of cross-linking. In contrast to Comparative Example 1, this composition does not contain significant amount of volatile byproducts after cross-linking.

The results of Comparative Examples (“C.E.”) 2 and 3, and Examples (“I.E.”) 1, 2, and 3 are shown in Table 1, below:

TABLE 1
Cross-linking Extent of Samples

| | PE1 Content | PE2 Content | HALS Content | MH-ML |
|---|---|---|---|---|
| Example | (%) | (%) | (%) | (inch-pounds) |
| C.E. 2 | 99 | — | 1 | 0.01 |
| C.E. 3 | — | 99 | 1 | 0.02 |
| I.E. 1 | 24.5 | 74.5 | 1 | 0.46 |
| I.E. 2 | 49.5 | 49.5 | 1 | 1.06 |
| I.E. 3 | 74.5 | 24.5 | 1 | 1.34 |

### Example 4

### Cable Preparation with Interpolymer Blend

Prepare Copolymer A using a high pressure polymerization reactor: ethylene and acrylic acid are copolymerized to form poly(ethylene-co-acrylic acid) having 3 wt % acrylic acid.

Prepare Copolymer B using a high pressure polymerization reactor: ethylene and glycidyl methacrylate are copolymerized to form poly(ethylene-co-glycidyl methacrylate) having 3 wt % glycidyl methacrylate.

Prepare Insulation Compound A by melt compounding 49.8 wt % copolymer A, 49.8% wt % copolymer B, and 0.4 wt % of antioxidant (tris(4-t-butyl-3-hydroxy-2,6-dimethylbenzyl)isocyanurate; available as Cyanox™ 1790) at 150° C., extruding with melt filtration through a 500 mesh screen, then pelletizing to provide insulation compound A.

Prepare Masterbatch A by melt compounding 5 wt % of 2-methylimidazole (cross-link catalyst) into low density polyethylene (“LDPE”) at 150° C., extruding with melt filtration through a fine screen, then pelletizing to provide Masterbatch A.

Prepare Cable 1 by dry blending 95 wt % of Insulation Compound A and 5 wt % of Masterbatch A and then extruding at 140° C. onto a cable core simultaneously with a semiconductive conductor shield and insulation shield (based on the same cross-linkable resin containing conductive carbon black) in a triple extrusion head. After passing through a hot nitrogen tube (CV tube) the cross-linked cable core is immediately ready for jacketing without a degassing step.

### Examples 5 and 6

### Cable Preparation with Terpolymer

Prepare Terpolymer A using a high pressure polymerization reactor to copolymerize ethylene, acrylic acid, and glycidyl methacrylate to form poly(ethylene-co-glycidyl methacrylate-co-acrylic acid) having 3 wt % glycidyl methacrylate and 3 wt % acrylic acid.

Prepare Terpolymer B using a high pressure polymerization reactor to copolymerize ethylene, maleic anhydride, and glycidyl methacrylate to form poly(ethylene-co-glycidyl methacrylate-co-maleic anhydride) having 3 wt % maleic anhydride and 3 wt % glycidyl methacrylate.

Prepare Insulation Compound B by melt compounding 99.6 wt % Terpolymer A and 0.4 wt % antioxidant Cyanox™ 1790 at 150° C., extruding with melt filtration through a 500 mesh screen, then pelletizing.

Prepare Insulation Compound C by melt compounding 99.6 wt % Terpolymer B and 0.4 wt % antioxidant Cyanox™ 1790 at 150° C., extruding with melt filtration through a 500 mesh screen, then pelletizing.

Prepare Cable 2 by dry blending 95 wt % of Insulation Compound B and 5 wt % Masterbatch A, then extruding at 140° C. onto a cable core simultaneously with a semiconductive conductor shield and insulation shield (based on the same cross-linkable resin containing conductive carbon black) in a triple extrusion head. After passing through a hot nitrogen tube (CV tube) the cross-linked cable core is immediately ready for jacketing without a degassing step.

Prepare Cable 3 by dry blending 95 wt % of Insulation Compound C and 5 wt % Masterbatch A, then extruding at 140° C. onto a cable core simultaneously with a semiconductive conductor shield and insulation shield (based on the same cross-linkable resin containing conductive carbon black) in a triple extrusion head. After passing through a hot nitrogen tube (CV tube) the cross-linked cable core is immediately ready for jacketing without a degassing step.

### Example 7

### 1.5:1 PE1:PE2 with 2-Methylimidazole Catalyst

Prepare a composition (I.E. 4) containing 59.61 wt % PE1, 40.14 wt % PE2, and 0.25 wt % of 2-Methylimidazole according to the above-described procedure. Evaluate the resulting sample rheologically, as described above, on a TA Instruments (New Castle, Del.) AR-G2 rheometer using parallel-plate geometry to determine storage modulus versus curing time at 200° C. The storage modulus increases over time, as shown in Table 2.

TABLE 2
Storage Modulus During Cross-linking

| Cure time at 200° C. | Storage modulus |
|---|---|
| (minutes) | (Pa) |
| 0 | 2 × 10⁵ |
| 5 | 6 × 10⁵ |
| 10 | 8 × 10⁵ |
| 40 | 1 × 10⁶ |

### Numerical Ranges

Numerical ranges include all values from and including the lower and the upper values, in increments of one unit, provided that there is a separation of at least two units between any lower value and any higher value. As an example, if a compositional, physical or other property, such as, for example, molecular weight, wt % ages, is from 100 to 1,000, then the intent is that all individual values, such as 100, 101, 102, and sub ranges, such as 100 to 144, 155 to 170, 197 to 200, are expressly enumerated.

1. A composition comprising:
a first interpolymer comprising ethylene monomer residues and residues of a first comonomer having one or more functionalities selected from the group consisting of carboxylic acid and carboxylic acid anhydride;
a second interpolymer comprising ethylene monomer residues and residues of a second comonomer having epoxide functionality; and
a catalyst.

2. The composition of claim 1, wherein said first interpolymer and said second interpolymer are present in the form of a blend, wherein at least 50 volume percent of said blend is a homogeneous blend.

3. The composition of claim 1, wherein said first interpolymer is present in an amount in the range of from 75 to 95 weight percent based on the combined weight of said first and second interpolymers.

4. The composition of claim 1, wherein said first comonomer comprises maleic anhydride and/or acrylic acid, wherein said second comonomer comprises glycidyl methacrylate.

5. The composition of claim 1, wherein said first interpolymer comprises said first comonomer residues in an amount in the range of from 0.5 to 10 weight percent, wherein said second interpolymer comprises said second comonomer residues in an amount in the range of from 0.5 to 20 weight percent.

6. An insulated cable composition comprising:
a conductor; and
an insulation material,
wherein said insulation material comprises an at least partially cross-linked polymeric network comprising a first interpolymer and a second interpolymer,
wherein said first interpolymer comprises ethylene monomer residues and residues of a first comonomer having one or more functionalities selected from the group consisting of carboxylic acid and carboxylic acid anhydride,
wherein said second interpolymer comprises ethylene monomer residues and residues of a second comonomer having epoxide functionality.

7. A process for preparing an insulated cable, said process comprising:
(a) providing a conductor and a cross-linkable material;
(b) at least partially surrounding said conductor with at least a portion of said cross-linkable material; and
(c) cross-linking at least a portion of said cross-linkable material in the substantial absence of both free-radical initiators and bis-azide cross-linkers to thereby provide an insulation material,
wherein said cross-linkable material comprises a first interpolymer comprising ethylene monomer residues and residues of a first comonomer having at least one functionality selected from the group consisting of carboxylic acid and carboxylic acid anhydride,
wherein said cross-linkable material comprises a second interpolymer comprising ethylene monomer residues and residues of a second comonomer having epoxide functionality.

8. The process of claim 7, wherein said first comonomer comprises maleic anhydride and/or acrylic acid, wherein said second comonomer comprises glycidyl methacrylate.

9. The process of claim 7, wherein said surrounding of step (b) is performed by co-extruding said cross-linkable material and said conductor to thereby produce an extruded intermediate cable, wherein said cross-linkable material further comprises a catalyst.

10. The process of claim 9, wherein said cross-linking of step (c) is performed by passing said extruded intermediate cable through a curing zone having a temperature of at least 175° C., wherein said catalyst comprises 2-methylimidazole.
